(19) United States
(12) Patent Application Publication
(10) Pub. No.: US 2008/0014324 A1
(43) Pub. Date: Jan. 17, 2008

(54) Taco Frying Apparatus

(76) Inventor: David W. Darnell, Lee's Summit, MO (US)

Correspondence Address: BLACKWELL SANDERS LLP, 4801 Main Street, Suite 1000, KANSAS CITY, MO, 64112, US

(21) Appl. No.: 11/457,514

(22) Filed: Jul. 14, 2006

(51) Int. Cl. A21D 10/00

(52) U.S. Cl. 426/549

(57) ABSTRACT

The present invention is directed to frying apparatus and a method of using a frying apparatus. In particular, the present invention relates to a frying apparatus for use in forming and frying taco shells and a method of forming and frying taco shells. The taco frying apparatus generally includes a frame assembly having a handle, a hanger, a first mold array and a second mold array including a plurality of mold assemblies, and a longitudinal axis A.

### BACKGROUND OF THE INVENTION

This invention relates generally to a deep-frying apparatus and a method of using a deep-frying apparatus. In particular, the present invention relates to a deep-frying apparatus for use in forming and frying taco shells and a method of forming and frying taco shells.

In commercial and some residential kitchens, fryers such as deep fat fryers, may be used to cook food products. For example, deep fat fryers, or gas fryers, are commercially used by restaurants, institutional kitchens, and fast food establishments for cooking a variety of food products, such as taco shells, fried chicken, french fries, fish, and the like. Food products are cooked by immersing them within a fryer vat that is filled with a heated, liquid cooking medium, such as melted shortening, vegetable oil, or the like. The cooking medium may be heated using a flow of heated gas that is forced or drawn through flow passages that are in thermal communication with wall portions of the fryer vat or are disposed within the vat itself in order to increase the heat transfer to the cooking medium. Other fryers may employ electric coils to melt a solid cooking medium, heat the cooking medium to a desired cooking temperature, and maintain the cooking medium at the desired temperature during the cooking cycle.

Taco shells, in particular, present unique problems during frying. In typical commercial kitchens, a quantity of meat is placed in the center of a flour or corn tortilla. The tortilla is then folded in half and secured at its edges with toothpicks. The folded and secured tortilla is then placed in a conventional fryer basket and lowered into a vat of hot oil for frying. After the desired amount of time has elapsed or the desired crispness attained, the taco shell is raised from the deep frying vat and removed from the fryer basket. The toothpicks are then removed thereby opening the edges of the taco shell for insertion of cold ingredients into the shell. However, in addition to being time-consuming, this process allows hot oil to enter the interior of the taco shell or, should the toothpicks fall out, the taco contents will spill into the hot oil. Moreover, the toothpicks are less hygienic than what is desirable in the restaurant industry and are often reused.

Accordingly, there is a need in the art for a taco shell frying apparatus that reduces the amount of time necessary to prepare a taco, is easier to handle, and more hygienic than conventional taco frying baskets or other apparatus.

### SUMMARY OF THE INVENTION

The present invention is directed to frying apparatus and a method of using a frying apparatus. In particular, the present invention relates to a frying apparatus for use in forming and frying taco shells and a method of forming and frying taco shells.

### BRIEF DESCRIPTION OF THE SEVERAL VIEWS OF THE DRAWING

In the accompanying drawings that form a part of the specification and that are to be read in conjunction therewith and in which like reference numerals are used to indicate like parts in the various views:

FIG. 1 is a right perspective view of the frying apparatus in accordance with one embodiment of the present invention;

FIG. 2 is a left elevational view of the frying apparatus in accordance with one embodiment of the present invention;

FIG. 3 is a fragmentary side elevational view of an individual clamp assembly of the frying apparatus in a closed position in accordance with one embodiment of the present invention;

FIG. 4 is a fragmentary side elevational view of an individual clamp assembly of the frying apparatus in an open position in accordance with one embodiment of the present invention;

FIG. 5 is a right plan view of a single taco frying apparatus in accordance with one embodiment of the present invention; and

FIG. 6 is a right perspective view of a single taco frying apparatus in accordance with one embodiment of the present invention.

### DETAILED DESCRIPTION OF THE INVENTION

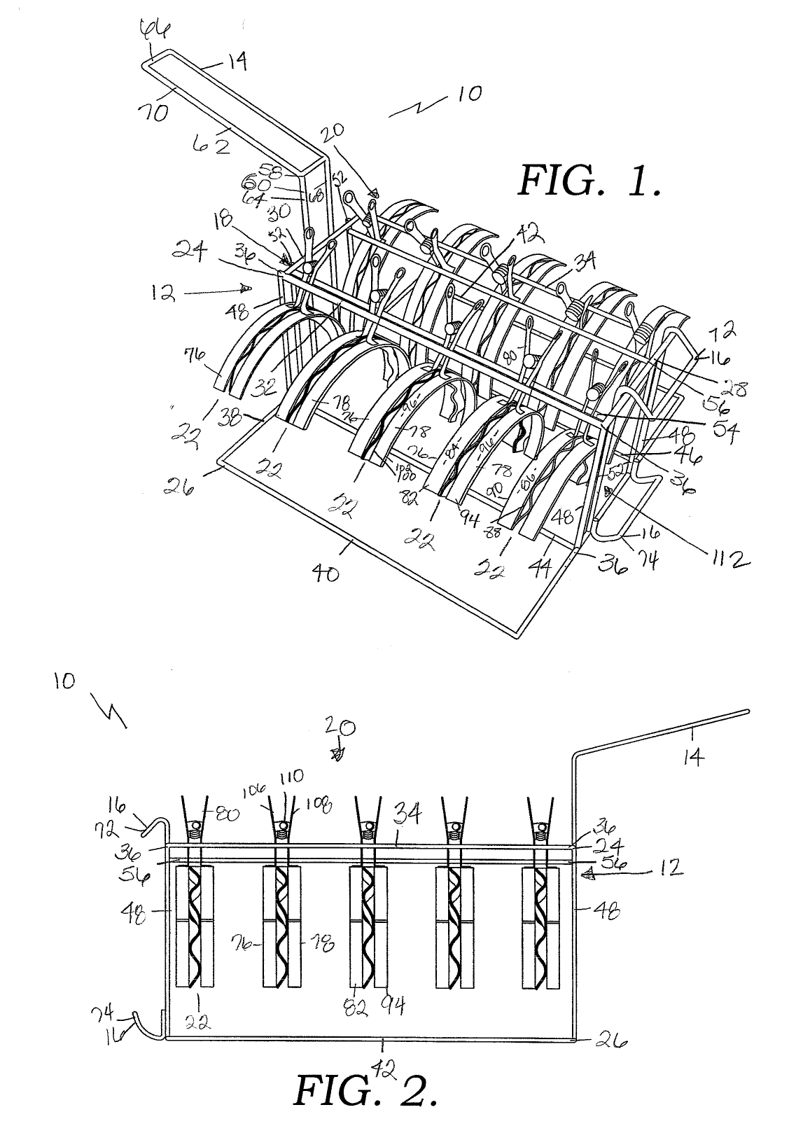

A frying apparatus 10 embodying various features of the invention is shown in the drawings. As shown in FIGS. 1 and 2, frying apparatus 10 generally includes a frame assembly 12 having a handle 14, a hanger 16, a first mold array 18 and a second mold array 20 including a plurality of mold assemblies 22, and a longitudinal axis A. Apparatus 10 is preferably formed of metal, such as steel, that is capable of withstanding the high temperatures of the hot oil in a frying vat (not shown). However, it will be appreciated by one skilled in the art that any heat-tolerant material capable of withstanding damage or melting in hot oil would be suitable for use in apparatus 10 including, but not limited to, metal, plastic, styrene, and the like.

Frame assembly 12 includes an upper rim 24 of any desired geometry, such as oval, square or rectangular, and a lower rim 26 of a geometry substantially similar to that of upper rim 24. Lower rim 26 circumscribes a larger surface area than the surface area circumscribed by upper rim 24. In a rectangular configuration as shown in FIG. 1, upper rim 24 includes a front edge 28, a rear edge 30, a right edge 32, and a left edge 34. Lower rim 26 also includes a front edge 36, a rear edge 38, a right edge 40 and a left edge 42. A first cross member 44 and a second cross member 46 extend longitudinally between front edge 36 and rear edge 38 of lower rim 26 such that members 44 and 46 are spaced apart in a substantially parallel relationship to one another as well as to right and left edges 40 and 42. Cross members 44 and 46 provide stability and support to frame assembly 12. Lower rim 26 is spaced apart from upper rim 24 by a first set of four uprights 48 so that upper rim 24 and lower rim 26 are in a substantially parallel relationship to one another. Uprights 48 extend upwardly from lower rim 26 to each of four corners 50 of upper rim 24 so that upper rim 24 is uniformly supported from each corner 50 and is spaced apart in a substantially parallel relationship from lower rim 26 at a predetermined height. A second set of four uprights 52 spaced inwardly from first uprights 48 extend between upper and lower rims 24 and 26. A third cross member 54 and a fourth cross member 56 extend longitudinally between uprights 52 such that cross members 54 and 56 are spaced apart in a substantially parallel relationship to one another as well as to right and left edges 32 and 34 of upper rim 24. Each end of cross members 54 and 56 is preferably affixed to an upper portion of uprights 52 disposed below upper rim 24 such that cross members 54 and 56 are also disposed in a lower horizontal plane than right and left edges 40 and 42 of upper rim 24.

Handle 14 includes a first portion 60 and a second portion 62. First portion 60 includes two vertical members 64 extending upwardly from a center portion of lower rim rear edge 38, and terminates with a cross bar 58 extending between vertical members 64 at a position disposed above rear edge 30 of upper rim 24. Vertical members 64 may be affixed to rear edge 30 for support and stability. It will be appreciated by those skilled in the art that first portion 60 should be extended upwardly to a position high enough to allow frame assembly 12 to be substantially immersed in hot oil yet allow a top portion 68 of vertical members 64 extending above rear edge 30 of upper rim 24 to remain above and free of the hot oil.

Second portion 62 of handle includes a second set of two vertical members 70 extending generally upwardly at an angle from first cross bar 58 and terminates with a second cross bar 66 extending between vertical members 70. It will be appreciated by those skilled in the art that the angle of second portion 62 is preferably from about 10-40° from a horizontal plane, but may extend at any desired angle to aid in grasping, lifting and carrying of apparatus 10 by a user.

Hanger 16 includes first hanging mount 74 and second hanging mount 74 for use in securely hanging or mounting frame assembly 12 within a hot oil vat or the like.

Each of first mold array 18 and second mold array 20 includes at least one mold assembly 22. As shown in FIGS. 1 and 2, each mold array 18 and 20 includes five mold assemblies 22 arranged longitudinally. It will be appreciated that any number of mold assemblies 22 may be used depending upon the desired application and intended use of apparatus 10. Each mold assembly 22 includes a first mold member 76, a second mold member 78, and a clamp or clip assembly 80. First mold member 76 includes a generally flat or planar strip formed into a first generally u-shaped or arcuate frame 82 having a top surface 84, bottom surface 86, inner surface 88, and outer surface 90. Affixed to substantially the entire length of inner surface 88 is a first scalloped press 92. Second mold member 78 also includes a generally flat or planar strip formed into a second generally u-shaped or arcuate frame 94 having a top surface 96, a bottom surface 98, an inner surface 100, and an outer surface 102. Affixed to substantially the entire length of inner surface 100 is a second scalloped press 104. Scalloped presses 92 and 104 have a substantially identical configuration for complementary engagement thereof.

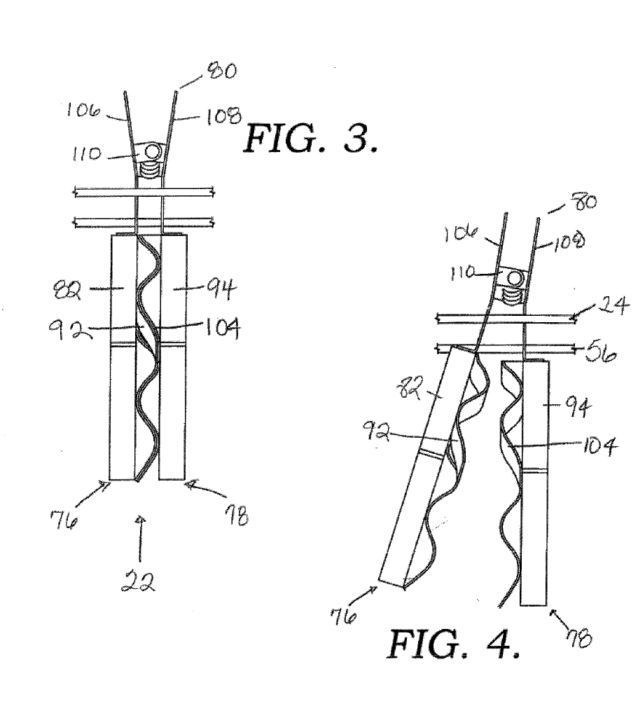

Turning now to FIGS. 3 and 4, clamp or clip assembly 80 includes first and second arms 106 and 108, respectively, and a spring mechanism 110 disposed therebetween. A proximal end of arm 106 is affixed to top surface 84 of first arcuate frame 82 and a proximal end of arm 108 is affixed to top surface 96 of second arcuate frame 94. In another embodiment, arms 106 and 108 are integrally formed with mold members 76 and 78. Spring mechanism 110 is disposed between arms 106 and 108 and is used to bias mold members 76 and 78 into a closed position as shown in FIG. 3 thereby holding mold members 76 and 78 firmly closed with scalloped presses 92 and 104 in matingly or complementary engagement. It will be appreciated that any suitable standard spring mechanism such as those used on potato chip bag clips or binder clips may be used for spring mechanism 110. When arms 106 and 106 are squeezed together by a user, mold members 76 and 78 separate, as shown in FIG. 4, to enable insertion or removal of a tortilla.

Each mold assembly 22 is coupled to frame assembly 12 by inserting clip assembly 80 through the space between left edge 34 of upper rim 28 and third cross member 54 and/or right edge 32 of upper rim 28 and fourth cross member 56. Because cross members 54 and 56 are disposed in a lower horizontal plane than upper rim 28, mold assembly 22 may sit at an angle relative to the horizontal plane. In the embodiment shown in FIG. 1 mold assembly 22 sits on an angle from the horizontal plane of from about 20-40°, more preferably 25-35°, and most preferably 30° to enable hot oil to drain off when apparatus 10 is removed from a hot oil vat. It is, however, within the scope of this invention for mold assembly 22 to sit horizontally within frame assembly 12 and not at an angle.

In use, after meat has been place in the center of a flat uncooked tortilla, the tortilla is folded generally in half to form a generally semi-circular shape wherein the edges of the tortilla meet together. The user then squeezes arms 106 and 108 of clip assembly 80 thereby separating and opening mold members 76 and 78. The edges of the tortilla are placed between scalloped presses 92 and 104 and the user releases clip assembly arms 106 and 108 to close mold members 76 and 78 together. The tortilla edges are thereby pressed between scalloped presses 92 and 104 as presses 92 and 104 move to a closed position such that the complementary engagement of presses 92 and 104 creates a scalloped shape in the tortilla edges and also seals the tortilla edges together. It will be appreciated that one or more tortillas may be inserted into one or mold assemblies 22 in this manner. Apparatus 10 is then lifted by a user by handle 14 and securely placed into a deep fryer or other type of hot oil vat by hanging or mounting frame assembly 12 in the fryer via hanger 16. After a desired amount of time has elapsed (e.g., 20 seconds) or the tortilla has reached the desired crispness, the user grasps handle 14, disengages hanger 16 from the interior of the fryer, and lifts apparatus 10 out of the fryer. Excess oil is drained off by holding apparatus 10 over the fryer whereby excess oil drips down the tortillas (now taco shells) toward the center of frame assembly 12 by virtue of the angle at which mold assemblies 22 are sitting relative to frame assembly 12. The user may then squeeze clip assembly arms 106 and 108 together to open mold members 76 and 78 thereby releasing the taco shell from scalloped presses 92 and 104. The top scalloped edge of the taco shell may then be tapped to split the edges apart and cold ingredients may then be added to the taco shell for completion of an edible taco food product.

The embodiments discussed hereinabove are directed to a frying apparatus having multiple mold assemblies for commercial use wherein multiple tacos may be fried at one time. However, it is also contemplated by the present invention to provide a single taco frying apparatus for consumer or residential use.

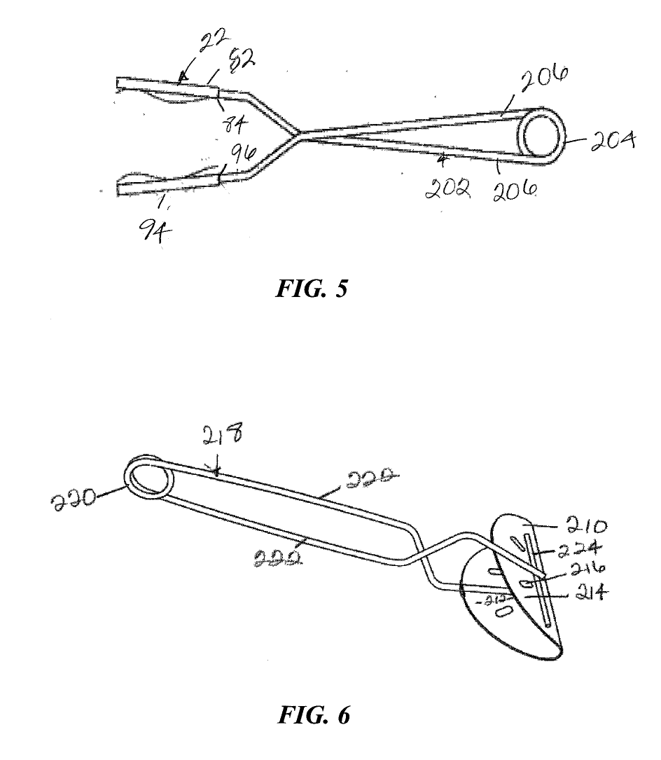

In one embodiment of the single mold frying apparatus 10 shown in FIG. 5, a single mold assembly 22, as described hereinabove, is provided with a handle rod 202 is configured such that a spring mechanism 204 is formed at a distal end and two arms 206 extend outwardly from spring mechanism 204. Arms 206 cross one another near a lower portion of handle 202 and terminate at each end by fixedly attaching each end to the top surface surface 84, 96 of each arcuate frame 82 and 94. When squeezed, arms 206 bias and frames 82 and 94 move into an open position for insertion or removal of a tortilla.

In another embodiment of single taco frying apparatus 10 shown in FIG. 6, a flat circular member formed into a u-shaped or a taco shell-shaped mold 210 is provided having an inner surface 212 and an outer surface 214 with apertures 216 formed therethrough for drainage of excess hot oil after frying. A handle rod 218 is configured such that a spring mechanism 220 is formed at a distal end and two arms 222 extend outwardly from spring mechanism 220. Arms 222 cross one another near a lower portion of handle 218 and terminate at each end with a cross bar 224. When squeezed, arms 222 bias and cross bars 224 move into an open position for insertion or removal of a tortilla around outer surface 214 of mold assembly 210.

In use, a user grasps and squeezes handle 218 thereby releasing cross bars 224 from contact with outer surface 214 of mold 210. A soft tortilla is then wrapped around the outer surface 214 of mold 210. The user stops squeezing handle 218 thereby allowing cross bars 224 to return to a closed position and secure the tortilla on outer surface 214 of mold 210. The user then lowers mold 210 into a quantity of hot oil for a desired amount of time until tortilla has achieved the desired crispness. The user then raises mold 210 out of the hot oil vat, squeezes handle 218 thereby releasing cross bars 224 from mold and allowing the formed taco shell to be removed from mold 210.

From the foregoing, it may be seen that the inventive frying apparatus and method of using the same is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

We claim:

1. An apparatus for shaping and cooking an unshaped food product comprising:
a frame assembly; and
a mold array including at least one mold assembly;
wherein said mold assembly includes:
a first generally arcuate frame having an inner surface and a first scalloped press affixed to said inner surface;
a second generally arcuate frame having an inner surface and a second scalloped press affixed to said inner surface wherein said second scalloped press is configured for complementary engagement with said first scalloped press; and
a clip assembly for selectively moving said frames from a closed position to an open position.

2. The apparatus of claim 1, further comprising a plurality of mold assemblies.

3. The apparatus of claim 1, said mold assembly being arranged on said frame assembly at a 20-40° angle from a horizontal plane of said frame assembly.

4. The apparatus of claim 1, said frame assembly further comprising a handle.

5. The apparatus of claim 1, wherein said unshaped food product is a tortilla.

6. A method of forming and cooking an unshaped food product comprising the steps of:
(a) providing a fryer apparatus having:
a frame assembly; and
a mold array including at least one mold assembly;
wherein said mold assembly includes:
a first generally arcuate frame having an inner surface and a first scalloped press affixed to said inner surface;
a second generally arcuate frame having an inner surface and a second scalloped press affixed to said inner surface wherein said second scalloped press is configured for complementary engagement with said first scalloped press; and
a clip assembly for selectively moving said arcuate frames from a closed position to an open position;
(b) squeezing said clip assembly to open said arcuate frames;
(c) inserting edges of a folded tortilla between said scalloped presses
(d) releasing said clip assembly to close said arcuate frames;
(e) inserting said apparatus into a deep fryer;
(f) removing said apparatus from said deep fryer;
(g) squeezing said clip assembly to open said arcuate frames; and
(h) removing said tortilla from said mold assembly.

7. An apparatus for forming and cooking an unshaped food product comprising:
a handle having a first and second arm and a spring mechanism therebetween, each of said arms having a cross bar at the end thereof; and
a generally u-shaped mold disposed between said cross bars.
